(19) United States
(12) Patent Application Publication
(10) Pub. No.: US 2024/0214787 A1
(43) Pub. Date: Jun. 27, 2024

(54) METHOD FOR CELLULAR VEHICLE-TO-EVERYTHING AND DEVICE THEREOF

(71) Applicant: SAMSUNG ELECTRONICS CO., LTD., Suwon-si (KR)

(72) Inventor: Yanping Gao, Suzhou Industrial Park (CN)

(73) Assignee: SAMSUNG ELECTRONICS CO., LTD., Suwon-si (KR)

(21) Appl. No.: 18/386,488

(22) Filed: Nov. 2, 2023

(30) Foreign Application Priority Data
Dec. 26, 2022 (CN) 202211678193.7

(51) Int. Cl. H04W 4/40; H04W 72/543; H04W 72/566

(52) U.S. Cl. CPC H04W 4/40; H04W 72/543; H04W 72/566

(57) ABSTRACT

A method for cellular vehicle-to-everything and a device thereof are provided. The method includes: determining, by a processor, a service priority group corresponding to a vehicle-to-everything (V2X) service; and determining, by the processor, whether to use resources in exceptional resource pools for the V2X service based on the service priority group.

### CROSS-REFERENCE TO RELATED APPLICATION

This application claims priority to Chinese Patent Application No. 202211678193.7, filed on Dec. 26, 2022, in the China National Intellectual Property Administration, the disclosure of which is hereby incorporated by reference in its entirety.

### FIELD

The present disclosure relates to communication technology, and in particular, to a method for cellular vehicle-to-everything (C-V2X) and a device thereof.

### BACKGROUND

With the development of technology, the application of vehicle-to-everything (V2X) is becoming more and more widespread. V2X technology enables all-round communication between vehicles and the surrounding environment as well as a network, providing environmental awareness, information interaction and cooperative control capabilities for vehicle driving and traffic management applications. The 3rd Generation Partnership Project (3GPP) has proposed C-V2X, which takes advantage of a cellular network in terms of resource selection and allocation to realize safe and fast transmission of vehicle-to-everything information through various modes. With the continuous development of protocol standards, the C-V2X has now gone through two stages, LTE-V2X and NR-V2X.

The C-V2X supports two kinds of resource scheduling methods, scheduling resource allocation and autonomous resource selection. In the method of autonomous resource selection (e.g., mode 2 of NR-V2X), UE has two types of resource pools, i.e., a normal resource pool and an exceptional resource pool. A UE selects resources in normal resource pools through a result of sensing. When the normal resource pools are unavailable, the UE uses resources in exceptional resource pools based on random selection. Because the resources are randomly selected in the exceptional resource pools, resource conflicts among UEs cannot be avoided and reliability of high priority service transmission may be impacted.

### SUMMARY

One or more example embodiments address one or more of the above-described challenges.

According to an aspect of an example embodiment, a method for cellular vehicle-to-everything (C-V2X), includes: determining, by a processor, a service priority group corresponding to a vehicle-to-everything (V2X) service; and determining, by the processor, whether to use resources in exceptional resource pools for the V2X service based on the service priority group.

According to an aspect of an example embodiment, a device for cellular vehicle-to-everything (C-V2X), includes: one or more memories storing instructions; and one or more processors configured to execute the instructions to: determine a service priority group corresponding to a vehicle-to-everything (V2X) service; and determine whether to use resources in exceptional resource pools for the V2X service based on the service priority group.

According to an aspect of an example embodiment, a non-transitory computer readable recording medium having embodied thereon a program, which when executed by a processor, controls a method, the method including: determining a service priority group corresponding to a vehicle-to-everything (V2X) service; and determining whether to use resources in exceptional resource pools for the V2X service based on the service priority group.

It should be understood that the above general description and the later detailed description are provided as examples.

### BRIEF DESCRIPTION OF THE DRAWINGS

The above and other aspects will be more apparent from the following description of example embodiments, taken in conjunction with the accompanying drawings, in which:

FIG. 1 illustrates a basic architecture of cellular vehicle-to-everything according to example embodiments.

FIG. 2 illustrates a protocol stack architecture for a UE according to example embodiments.

FIG. 3 illustrates a flowchart of a method for cellular vehicle-to-everything according to example embodiments.

FIG. 4 illustrates a decision flowchart of a method for cellular vehicle-to-everything according to example embodiments.

FIG. 5 illustrates a block diagram of a device for cellular vehicle-to-everything according to example embodiments.

FIG. 6 illustrates a block diagram of an electronic device according to example embodiments.

### DETAILED DESCRIPTION

Hereinafter, example embodiments are described with reference to the accompanying drawings, in which like reference numerals are used to depict the same or similar elements, features, and structures. Embodiments described herein are example embodiments, and thus, the present disclosure is not limited thereto, and may be realized in various other forms. Each example embodiment provided in the following description is not excluded from being associated with one or more features of another example or another example embodiment also provided herein or not provided herein but consistent with the present disclosure.

As used herein, the terms “1st” or “first” and “2nd” or “second” may use corresponding components regardless of importance or order and are used to distinguish a component from another component without limiting the components. It will be also understood that, although in example embodiments related to methods or flowcharts, a step or operation is described later than another step or operation, the step or operation may be performed earlier than the other step or operation unless the step or operation is described as being performed after the other step or operation. The example embodiments described herein do not represent all example embodiments that are consistent with the disclosure. Rather, the described example embodiments are examples of devices and methods that are consistent with some aspects of the disclosure, as detailed in the appended claims.

Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

A UE has two types of resource pools in autonomous resource selection method (e.g., mode 2 of NR-V2X), i.e., normal resource pools and exceptional resource pools. As specified in 3GPP TS38.331 and TS38.321 for the behavior of the UE, if resources configured in sl-TxPoolSelectedNormal (i.e., a normal resource pool) are sensed as unavailable, the UE may configure lower layers to use resource pools indicated by sl-TxPoolExceptional (i.e., an exceptional resource pool) based on random selection to perform side-link resource allocation mode 2 (i.e., mode 2 of NR-V2X). Because the resources are randomly selected in the exceptional resource pools, resource conflicts among UEs cannot be avoided and the reliability of high priority service transmission is negatively impacted.

To solve the above problems, one or more example embodiments provide a method for cellular vehicle-to-everything and a device thereof, in which the UE determines the use of resources in exceptional resource pools according to the service priority group, which improves reliability of high priority service transmission and reduces conflicts caused by randomly selected resources in the exceptional resource pools, thereby improving resource utilization.

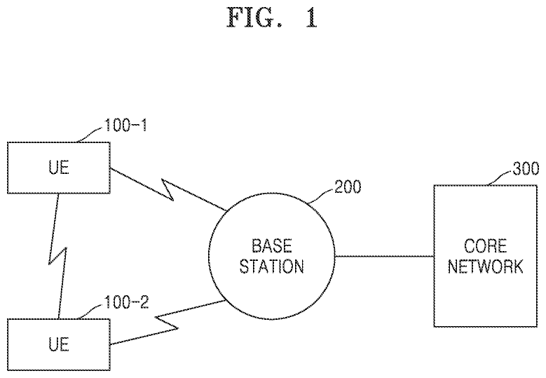

FIG. 1 illustrates a basic architecture of cellular vehicle-to-everything according to example embodiments.

Referring to FIG. 1, the basic architecture of the cellular vehicle-to-everything may include multiple user equipments (UEs) 100 (although FIG. 1 illustrates UE 100-1 and UE 100-2, example embodiments are not limited two to UEs), a base station 200, and a core network 300. The vehicle-to-everything technology enables all-round communication between vehicles and the surrounding environment as well as a network, including the vehicle-to-vehicle (V2V), the vehicle-to-road (infrastructure) (V2I), the vehicle-to-people (V2P), and the vehicle-to-network (V2N), etc., providing environmental awareness, information interaction and cooperative control capabilities for vehicle driving and traffic management applications. A UE in the basic architecture may be a vehicle user equipment (V-UE), a road user equipment (I-UE), a pedestrian user equipment (P-UE), or a network user equipment (N-UE), etc. The UE may communicate through a base station. The base station in the basic architecture may be a base station (BS), a NodeB, an eNodeB, a radio network controller (RNC), a base station controller (BSC), a basic transceiver base station (BTS), transceiver function (TF), a connection point, etc. The UE may access to the core network through the base station in the radio access network. The core network in the basic architecture may be the evolved packet core (EPC) or the 5G core network (i.e., 5GC). The EPC may include the mobility management entity (MME), the packet data network gateway (PGW), the service gateway (SGW), the policy and charging rule function (PCRF) and the home subscriber server (HSS), and other network elements. The 5GC may include the access and mobility management function (AMF), the session management function (SMF), the user plane function (UPF), the authentication server function (AUSF), the policy control function (PCF), the unified data management (UDM), and other network elements. The above mentioned base station 200 and core network 300 are corresponding entities in wireless communication networks and will not be described in detail here.

It should be understood that the basic architecture of the cellular vehicle-to-everything is provided as an example, and the basic architecture of the cellular vehicle-to-everything may also be, for example, a direct mode architecture, that is, an architecture in which user equipment transmits data through a direct link without passing through a base station. The illustration for the basic architecture of the cellular vehicle-to-everything is also provided as an example, only and example embodiments are not limited thereto.

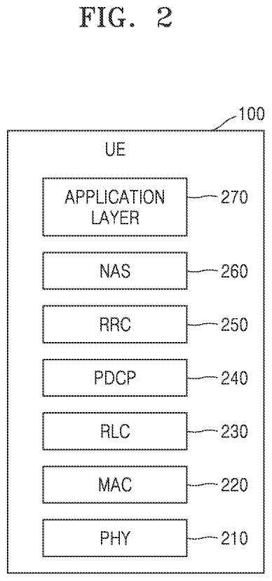

FIG. 2 illustrates a protocol stack architecture of a UE according to example embodiments.

Referring to FIG. 2, the protocol stack of the UE 100 from bottom to top includes the physical layer (PHY) 210, the media access control (MAC) 220, the radio link control (RLC) 230, the packet data convergence protocol (PDCP) 240, the radio resource control (RRC) 250, the non-access (NAS) 260, and the application layer 270. The PHY 210, which is a part of Layer 1, is responsible for providing various logical channels of an air interface and for handling functions such as encoding and decoding, modulation and demodulation, and mapping of multiple antennas. Layer 2 includes the MAC 220, the RLC 230, and the PDCP 240. The MAC 220 defines and allocates logical channels of the air interface, enabling these channels to be shared by different UEs. The RLC 230 is the communication protocol between the UE and the base station, communicating with the PDCP 240 through SAP (Service Access Point) and communicating with the MAC 220 via logical channels to ensure that data is received and transmitted in the same order. The PDCP 240 compresses and decompresses an IP header, transmits user data and maintains a sequence number of a wireless bearer set for a lossless wireless network service subsystem. The RRC 250 handles the Layer 3 messages of the control plane between the UE and the base station (e.g., eNodeB), and the NAS 260 is responsible for the information transfer between the UE and the core network. The application layer 270 provides an interface for applications used for communication and the underlying networks used for message transmission. The layers in the UE protocol stack architecture described above are the corresponding structural layers of the wireless communication protocol stack and will not be described in detail here.

C-V2X service data transmission includes the concept of “resource pool”. Resource pools at the UE side may be transmitted or pre-configured by the network side and may include the resources used for transmission and many transmission related parameters. For example, the resource pools may include a bitmap corresponding to the resource pool, a number of sub-channels, a size of each sub-channel, and a minimum RB index value corresponding to the sub-channel. In the autonomous resource selection method, the Layer 2 (including the MAC 220, the RLC 230 and the PDCP 240) of the UE is responsible for selecting resources in the configured resource pools, and thus in the case of transmitting the resource pools by the network side, the network side may configure the resource pools to corresponding Layer 2 of the UE via RRC signaling.

The UE may receive a data transmission request for a V2X service from an upper layer (e.g. the application layer 270). The Layer 2 of the UE is responsible for selecting, based on the data transmission request, the resources in the resource pools and signal of the service data is transmitted on PHY 210 via the selected resources.

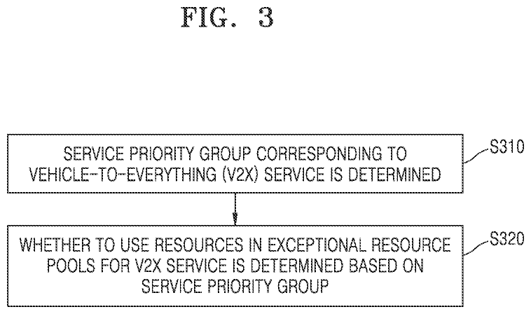

FIG. 3 illustrates a flowchart of a method for cellular vehicle-to-everything according to example embodiments. The method illustrated in FIG. 3 may be performed by a UE, such as the first UE 100-1 or the second UE 100-2 shown in FIG. 1.

Referring to FIG. 3, in operation S310, a service priority group corresponding to a vehicle-to-everything (V2X) service is determined.

According to example embodiments, whether resources in normal resource pools are available is determined based on a data transmission request for the V2X service. The determination of the service priority group corresponding to the vehicle-to-everything (V2X) service is performed based on the resources in the normal resource pools being unavailable.

In the autonomous resource selection method, a network side may configure exceptional resource pools for a UE in addition to normal resource pools. Here the autonomous resource selection mode may be, for example, mode 4 of LTE-V2X or mode 2 of NR-V2X.

In example embodiments, the UE first senses (i.e., resource sense) the use of resources in the normal resource pools after receiving the data transmission request for the V2X service from an upper layer (e.g., the application layer 270). Specifically, for example, the UE senses which resources in the normal resource pools are not used by other UEs and selects the unused resources in the normal resource pools for its own data transmission. If the UE senses that the resources in the normal resource pools are unavailable, e.g., all resources in the normal resource pools are already in use by other UEs, then the UE may consider using resources in the exceptional resource pools. In example embodiments, the UE may determine use of the resources in the exceptional resource pools based on the service priority group (or, alternatively, determine the processing method of the V2X service) in the case of the resources in the normal resource pools being unavailable. In this regard, the UE may determine the service priority group in which the V2X service is located. In addition, the UE may also determine to use the exceptional resource pools in special cases, such as during handover process, in case of radio link failure (RLF) or during a transition from idle to connected state.

According to example embodiments, the service group is determined from among a plurality of service priority groups according to a priority level value in quality of service (QOS) parameters of the V2X service and configuration information of the plurality of service priority groups. For example, the plurality of service priority groups may include: a first priority service group, a second priority service group and a third priority service group. The configuration information of the plurality of service priority groups may come from a pre-configuration, a network configuration, or an upper layer configuration of a user equipment (UE).

In example embodiments, every V2X service may carry quality of service QoS parameters, which may include, for example, a priority level, a resource type (e.g., a non-guaranteed bit rate (Non-GBR), or a guaranteed bit rate (GBR)), the packet error rate, etc. Among the QoS parameters, the priority level value identifies the priority of the V2X service, which corresponds to the relative importance of the service. For example, a lower value of the priority level may indicate a higher priority. The UE may include the configuration information of the plurality of service priority groups, which may be from a pre-configuration (pre-configured information), from a network configuration or from an upper layer configuration of the user equipment (UE). The pre-configuration may be a default configuration used when the UE initially connects to the network, the network configuration may be a network side configuration that is provided by the network as needed, and the upper layer configuration of the UE may be a UE side configuration that is provided by the UE as needed.

The priorities of the three configurations may be that the network configuration takes precedence over the upper layer configuration of the UE, while the upper layer configuration of the UE takes precedence over the pre-configuration. Then, in the absence of the network configuration and the upper layer configuration of the UE, the pre-configuration may be used by default. The configuration information of the plurality of service priority groups may include information about three groups divided according to the priority level value in QoS parameters of the service, and the plurality of service priority groups may include a high priority service group (i.e., a first priority service group), a medium priority service group (i.e., a second priority service group) and a low priority service group (i.e., a third priority service group). Specifically, for example, priority level values in the QOS parameters of the V2X service may range from 1 to 8. In a first case, the configuration information of the plurality of service priority groups may classify the priority level values of 1 and 2 in the QoS parameters as the high priority service group, the priority level values of 3 and 4 in the QoS parameters as the medium priority service group, and the priority level values of 5-8 in the QoS parameters as the low priority service group. Alternatively, in a second case the configuration information of the plurality of service priority groups may classify the priority level value of 1 in the QoS parameter as the high priority service group and the priority level values of 2-8 in the QoS parameter as the low priority service group. It should be understood that the range of the priority level values in the QoS parameters and the configuration information of the plurality of service priority groups herein are provided as examples, and example embodiments are not limited thereto.

In example embodiments, the UE may determine the service priority group in which the V2X service is located by dividing the V2X service into plurality of service priority groups based on the priority level value in the QoS parameters of the V2X service initiating the data transmission request and the configuration information of the plurality of service priority groups. For example, if the priority level value in the QoS parameter of the V2X service is 1, then according to the configuration information of the plurality of service priority groups mentioned above, the service priority group in which the V2X service is located is the high priority service group (the first priority service group) in both the first case and the second case. For another example, if the priority level value in the QoS parameter of the V2X service is 3, then according to the first case of the configuration information of the plurality of service priority groups, the service priority group in which the V2X service is located is the low priority service group (the third priority service group), while according to the second case of the configuration information of the plurality of service priority groups, the service priority group in which the V2X service is located is the medium priority service group (the second priority service group).

In operation S320, whether to use resources in exceptional resource pools for the V2X service is determined based on the service priority group.

According to example embodiments, the resources in the exceptional resource pools are used, based on random selection, to send data of the V2X service based on the service priority group being the first priority service group. Whether to use the resources in the exceptional resource pools for the V2X service is determined based on a channel busy ratio (CBR) based on ‘the service priority group being the second priority service group. And data transmission of the V2X service is cancelled based on the service priority group being the third priority service group.

In example embodiments, the configuration information of the plurality of service priority groups includes information about three groups divided according to the priority level value in QoS parameters of the V2X service, the plurality of service priority groups includes the high priority service group (i.e., the first priority service group), the medium priority service group (i.e., the second priority service group) and the low priority service group (i.e., the third priority service group). Then, the V2X services in the three groups may be correspondingly considered as a high priority service, a medium priority service and a low priority service. In the case that the service priority group in which the V2X service is located is the high priority service group, in order to improve reliability of the data transmission of the high priority V2X service, the resources in the exceptional resource pools are used, based on the random selection, to send the data of the V2X service. In the case that the service priority group in which the V2X service is located is the low priority service group, the data transmission of the V2X service is cancelled due to the low priority of V2X service itself, conflicts caused by randomly selected resources in the exceptional resource pools are reduced, and the reduction of resource conflicts improves the resource utilization. In the case that the service priority group in which the V2X service is located is the medium priority service group, the UE may also determine the use of resources in the exceptional resource pools for the V2X service based on the channel busy ratio (CBR). As shown above, the use of resources is determined through the combination of the priority service groups based on QoS (e.g., the priority level value in QoS parameters) and the random selection, improving the reliability of service transmission with high priority while reducing the conflicts caused by the random selection of resources in the exceptional resource pools and improving the resource utilization.

According to example embodiments, the resources in the exceptional resource pools may be used, based on the random selection, to send the data of the V2X service in the case of the CBR being less than a certain threshold or in the case of the UE not being configured to measure the CBR. The data transmission of the V2X service may be cancelled in the case of the CBR being greater than or equal to the certain threshold.

In the case that the service priority group in which the V2X service is located is the medium priority service group, a medium priority V2X service is not as important as the high priority service that may be directly determined to use resources, nor may it be directly discarded like the low priority service. In example embodiments, the channel busy ratio (CBR) is also introduced as a factor in determining whether to use resources in the exceptional resource pools. The channel busy ratio (CBR) is primarily used to characterize a degree of channel busy, e.g., CBR may be defined as the ratio of the portion of the received signal strength indicator (S-RSSI) observed in a subchannel for a specified duration exceeds a (pre)configured threshold. The UE may perform the CBR measurement for the band (or included subchannels) occupied by the resources pools for current transmission (e.g., the exceptional resource pools). In the case that a measured CBR is less than the certain threshold, indicating that the channel is not very busy at this time and is not prone to resource conflicts and collisions, then the resources in the exceptional resource pools are used, based on the random selection, to send the data of the V2X service. In the case that the measured CBR is greater than or equal to the certain threshold, indicating that the channel is busy and prone to resource conflicts and collisions, then the data transmission of the V2X services is cancelled. The certain threshold here may be set, for example, based on experience or based on actual conditions, but example embodiments are not limited thereto. In addition, the UE may not be configured to obtain the CBR measurement, for example when the UE is insensitive to the CBR measurement value or the CBR measurement result has little impact on the UE. At this time, the resources in the exceptional resource pools are also used based on the random selection to send the data of the V2X service, thus improving the transmission of V2X service.

As described above, according to the method for the cellular vehicle-to-everything of the example embodiments, the UE determines the use of resources in exceptional resource pools according to the service priority group, which improves the reliability of services transmission with high priority while reducing conflicts caused by randomly selected resources in the exceptional resource pools and improving resource utilization. In addition, in the case that the service priority group is the medium priority service group, the UE also determines the use of resources based on the channel busy ratio, refining the granularity of resource use determination, further reducing resource conflicts in the exceptional resource pools, and improving resource utilization.

The method for the cellular vehicle-to-everything according to the description above may be considered to include two parts, a configuration part and a resource management part, respectively. The configuration part saves the configuration of the service priority groups and the configuration of the resource pools (including the normal resource pools and the exceptional resource pools), while the resource management part determines the use of resources according to the decision flowchart described below.

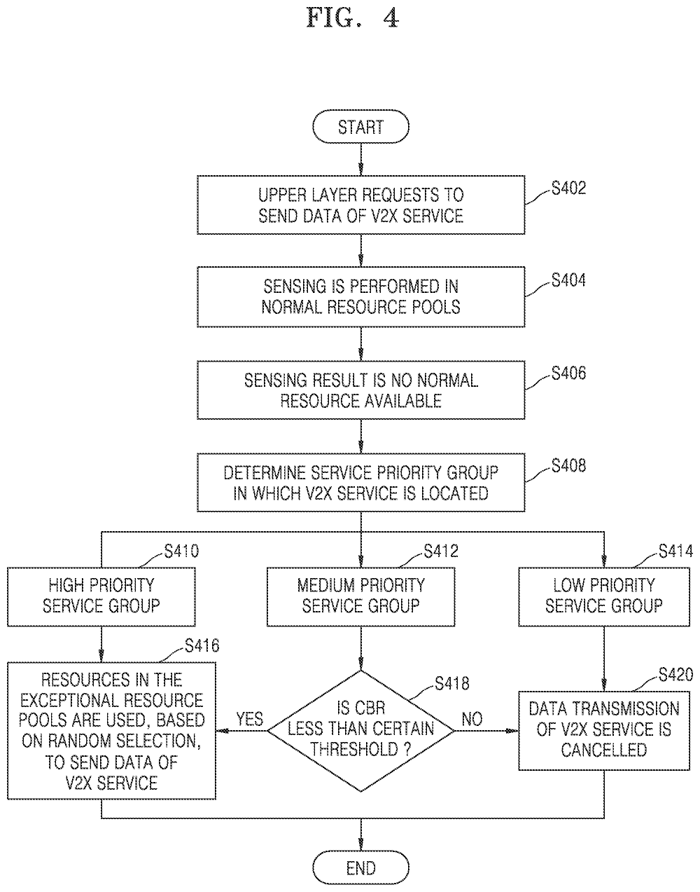

FIG. 4 illustrates a decision flowchart of a method for cellular vehicle-to-everything according to example embodiments.

Referring to FIG. 4, in operation S402, the upper layer requests to send data of a V2X service. Here, for example, it may be that the application layer 270 of a UE has data of the V2X service to be sent and the UE receives a request from the application layer 270 to send data of the V2X services. In operation S404, sensing is performed in normal resource pools. In response to the request from the upper layer, the UE senses use of resources in normal resource pools. In operation S406, the sensing result is no normal resource available. Here, for example, the UE senses that all resources in the normal resource pools are already used by other UEs and that there are no free resources in the normal resource pools. In operation S408, a service priority group in which the V2X service is located is determined. Here, the operation may also determine whether to use resources in exceptional resource pools for the V2X service according to the service priority group in which the V2X service is located. The configuration information of the plurality of service priority groups includes information about three groups divided according to a priority level value in QoS parameters of the service, and the plurality of service priority groups includes a high priority service group, a medium priority service group and a low priority service group. The V2X services in the three groups may be correspondingly considered as a high priority service, a medium priority service and a low priority services. In operation S410, the service priority group is the high priority service group, and at this time, the V2X service is the high priority service. To improve reliability of data transmission of V2X service with the high priority, the process advances to operation S416, in which the resources in the exceptional resource pools are used, based on random selection, to send data of the V2X service. In operation S414, the service priority group is the low priority service group, and at this time, the V2X service is the low priority service with a low level of importance. In order to reduce conflicts of randomly selected resources, the process advances to operation S420, in which the data transmission of the V2X service is cancelled.

In addition, in operation S412, the service priority group is the medium priority service group, and at this time, the V2X service is the medium priority service. Since the medium priority service is not as important as the high priority service, and cannot be directly discarded as the low priority service, a CBR measurement is determined and used to refine the processing method for the V2X service. In operation S418, it is determined whether a CBR is less than a certain threshold. In the case that the CBR is less than the certain threshold, indicating that the channel is not too busy and not prone to resource conflicts, the process advances to operation S416, in which the resources in the exceptional resource pools are used, based on the random selection, to send the data of the V2X service. In the case that the CBR is greater than or equal to the certain threshold, indicating that the channel is too busy and prone to resource conflicts and collisions, the process advances to operation S420, in which the data transmission of the V2X service is cancelled. Here, in the case that the UE is not configured to determine the CBR measurement, the resources in the exceptional resource pools are used, based on the random selection, to send the data of the V2X service, thus improving the transmission of V2X service.

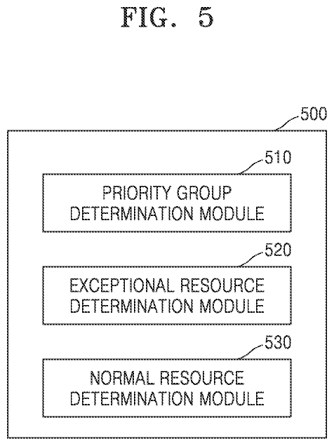

FIG. 5 illustrates a block diagram of a device for cellular vehicle-to-everything according to example embodiments. For example, the device 500 may be the UE 100.

Referring to FIG. 5, the device for the cellular vehicle-to-everything may include a priority group determination module 510 and an exceptional resource determination module 520, wherein the priority group determination module 510 may determine a service priority group corresponding to a vehicle-to-everything (V2X) service, the exceptional resource determination module 520 may determine whether to use resources in exceptional resource pools for the V2X service based on the service priority group.

According to example embodiments, the priority group determination module 510 may categorize the V2X service as one of several service priority groups according to a priority level value in quality of service (QOS) parameters of the V2X service and configuration information of the plurality of service priority groups. For example, the plurality of service priority groups may include a first priority service group, a second priority service group, and a third priority service group. The priority group determination module 510 may receive the configuration information of the plurality of service priority groups.

According to example embodiments, the exceptional resource determination module 520 may use, based on random selection, the resources in the exceptional resource pools to send data of the V2X service based on the service priority group being the first priority service group, determine whether to use the resources in the exceptional resource pools for the V2X service based on a channel busy ratio (CBR) based on the service priority group being the second priority service group, and cancel data transmission of the V2X service based on the service priority group being the third priority service group.

According to example embodiments, the exceptional resource determination module 520 may use, based on the random selection, the resources in the exceptional resource pools to send the data of the V2X service in the case of the CBR being less than a certain threshold or the UE not being configured to determine the CBR measurement, and may cancel data transmission of the V2X service in the case of the CBR being greater than or equal to the certain threshold. The exceptional resource determination module 520 may determine the channel busy ratio based on an amount of time that a received signal strength indicator exceeds a second threshold over a first time period.

According to example embodiments, the device for the cellular vehicle-to-everything may further include a normal resource determination module 530. The normal resource determination module 530 may determine whether resources in normal resource pools are available based on a data transmission request of the V2X service and perform the determination of the service priority group based on the resources in the normal resource pools being unavailable.

According to example embodiments, the configuration information of the service priority groups comes from a pre-configuration, a network configuration, or an upper layer configuration of a user equipment (UE).

According to example embodiments, priority level values in the QoS parameters of the V2X service range from 1 to 8, and the configuration information of the service priority groups may indicate the priority level values of 1 and 2 in the QoS parameters are the high priority service group, the priority level values of 3 and 4 in the QoS parameters are the medium priority service group, and the priority level values of 5-8 in the QoS parameters are the low priority service group. As another example, the priority level value of 1 in the QoS parameter may indicate the high priority service group and the priority level values of 2-8 in the QoS parameter may indicate the low priority service group.

As described above, according to the device for the cellular vehicle-to-everything of the example embodiments, the use of resources in the exceptional resource pools is determined according to the service priority group, which improves the reliability of high priority services transmission while reducing conflicts caused by randomly selected resources in the exceptional resource pools and improving resource utilization. In addition, in the case that the service priority group is the medium-priority service group, the use of resources is also determined based on the channel busy ratio, refining the granularity of resource use determination, further reducing resource conflicts in the exceptional resource pools, and improving resource utilization.

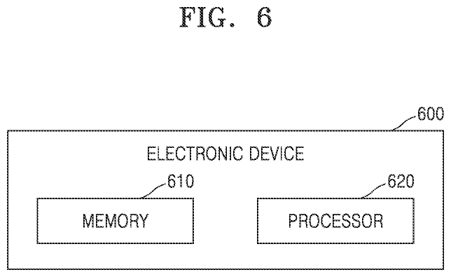

FIG. 6 illustrates a block diagram of an electronic device according to example embodiments. For example, the electronic device 600 may be the UE 100. Referring to FIG. 6, the electronic device 600 may include at least one memory 610 and at least one processor 620. The at least one memory may store a set of computer executable instructions therein, and when a set of computer-executable instructions (e.g., the set of computer executable instructions stored in the at least one memory 610) is executed by the at least one processor, the priority group determination module 510, the exceptional resource determination module 520 and the normal resource determination module 530 may be implemented, and the method for the cellular vehicle-to-everything according to example embodiments may be executed.

Here, the electronic device may not be a single electronic device, but may also be any collection of devices or circuits capable of executing the instructions (or instruction set) individually or in combination. The electronic device may also be part of an integrated control system or system manager, or may be configured to be an electronic device connecting via a local or remote (e.g., via wireless transmission) interface.

In an electronic device, the processor may include a central processing unit (CPU), a graphic processing unit (GPU), a programmable logic device, a dedicated processor system, a microcontroller, and/or a microprocessor. As an example and not a limitation, a processor may also include an analog processor, a digital processor, a microprocessor, a multi-core processor, a processor array, a network processor, and/or the like.

The processor may run instructions or code stored in the memory, wherein the memory may also store data. The instructions and/or data may also be sent, and/or received, over a network via a network interface device, wherein the network interface device may employ any known transmission protocol.

The memory may be integrated with the processor, for example, by arranging RAM or flash memory within an integrated circuit microprocessor. In addition, the memory may include a separate device, such as an external disk drive, a storage array, or other storage device. The memory and the processor may be operationally coupled or may communicate with each other, for example, via I/O ports, network connections, etc., so that the processor may read the files stored in the memory.

In addition, the electronic device may also include a video display (e.g., LCD) and a user interface (such as a keyboard, mouse, touch input device, etc.). All components of the electronic device may be connected to each other via a bus and/or network.

According to example embodiments, a computer-readable storage medium may also be provided, wherein a computer program is stored thereon, the program when executed may implement the method for the cellular vehicle-to-everything according to the present disclosure. Examples of computer-readable storage media herein include: read-only memory (ROM), random access programmable read-only memory (PROM), electrically erasable programmable read-only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disk memory, hard disk drive (HDD), solid state drive (SSD), card-based memory (such as, multimedia cards, Secure Digital (SD) cards and/or Extreme Digital (XD) cards), magnetic tapes, floppy disks, magneto-optical data storage devices, optical data storage devices, hard disks, solid state disks, and/or any other device, where the other device is configured to store the computer programs and any associated data, data files, and/or data structures in a non-transitory manner and to provide the computer programs and any associated data, data files, and/or data structures to a processor or computer, so that the processor or computer may execute the computer program. The computer program in the computer readable storage medium may run in an environment deployed in a computer device such as a terminal, client, host, agent, server, etc., and furthermore, in one example, the computer program and any associated data, data files and/or data structures are distributed on a networked computer system such that the computer program and any associated data, data files and/or data structures are stored, accessed, and/or executed in a distributed manner by one or more processors or computers.

According to the method for the cellular vehicle-to-everything and the device thereof of the example embodiments, the use of resources in the exceptional resource pools is determined according to the service priority group, which improves the reliability of high priority services transmission and reduces conflicts caused by randomly selected resources in the exceptional resource pools, thereby improving resource utilization. In addition, in the case that the service priority group is the medium-priority service group, the use of resources is also determined based on the channel busy ratio, refining the granularity of resource use determination, further reducing resource conflicts in the exceptional resource pools, and improving resource utilization.

While aspects of example embodiments have been particularly shown and described, it will be understood that various changes in form and details may be made therein without departing from the spirit and scope of the following claims.

What is claimed is:

1. A method for cellular vehicle-to-everything (C-V2X), comprising:
determining, by a processor, a service priority group corresponding to a vehicle-to-everything (V2X) service; and
determining, by the processor, whether to use resources in exceptional resource pools for the V2X service based on the service priority group.

2. The method of claim 1, wherein the determining the service priority group comprises:
determining the service priority group from among a plurality of service priority groups according to a priority level value in quality of service (QOS) parameters of the V2X service and configuration information of the plurality of service priority groups, wherein the plurality of service priority groups comprises a first priority service group, a second priority service group and a third priority service group.

3. The method of claim 2, wherein the determining whether to use resources in exceptional resource pools for the V2X service based on the service priority group comprises:
using, based on random selection, the resources in the exceptional resource pools to send data of the V2X service based on the service priority group being the first priority service group;
determining whether to use the resources in the exceptional resource pools for the V2X service based on a channel busy ratio based on the service priority group being the second priority service group; and
canceling data transmission of the V2X service based on the service priority group being the third priority service group.

4. The method of claim 3, wherein the determining whether to use the resources in the exceptional resource pools for the V2X service based on the channel busy ratio comprises:
using, based on the random selection, the resources in the exceptional resource pools to send the data of the V2X service based on the channel busy ratio being less than a first threshold; and
canceling the data transmission of the V2X service based on the channel busy ratio being greater than or equal to the first threshold.

5. The method of claim 3, further comprising determining the channel busy ratio based on an amount of time that a received signal strength indicator exceeds a second threshold over a first time period.

6. The method of claim 2, further comprising receiving the configuration information of the plurality of service priority groups.

7. The method of claim 1, the method further comprising:
determining whether resources in normal resource pools are available based on a data transmission request of the V2X service; and
performing the determining of the service priority group based on the resources in the normal resource pools being unavailable.

8. A device for cellular vehicle-to-everything (C-V2X), comprising:
one or more memories storing instructions; and
one or more processors configured to execute the instructions to:
determine a service priority group corresponding to a vehicle-to-everything (V2X) service; and
determine whether to use resources in exceptional resource pools for the V2X service based on the service priority group.

9. The device of claim 8, wherein the one or more processors are further configured to execute the instructions to:
determine the service priority group from among a plurality of service priority groups according to a priority level value in quality of service (QOS) parameters of the V2X service and configuration information of the plurality of service priority groups, wherein the plurality of service priority groups comprises a first priority service group, a second priority service group, and a third priority service group.

10. The device of claim 9, wherein the one or more processors are further configured to execute the instructions to:
use, based on random selection, the resources in the exceptional resource pools to send data of the V2X service based on the service priority group being the first priority service group;
determine whether to use the resources in the exceptional resource pools for the V2X service based on a channel busy ratio based on the service priority group being the second priority service group; and
cancel data transmission of the V2X service based on the service priority group being the third priority service group.

11. The device of claim 10, wherein the one or more processors are further configured to execute the instructions to:
use, based on the random selection, the resources in the exceptional resource pools to send the data of the V2X service based on the channel busy ratio being less than a first threshold; and
cancel the data transmission of the V2X service based on the channel busy ratio being greater than or equal to the first threshold.

12. The device of claim 10, wherein the one or more processors are further configured to execute the instructions to determine the channel busy ratio based on an amount of time that a received signal strength indicator exceeds a second threshold over a first time period.

13. The device of claim 9, wherein the one or more processors are further configured to execute the instructions to control the device to receive the configuration information of the service priority groups.

14. The device of claim 8, wherein the one or more processors are further configured to execute the instructions to:
determine whether resources in normal resource pools are available based on a data transmission request of the V2X service; and
perform the determining of the service priority group based on the resources in the normal resource pools being unavailable.

15. A non-transitory computer readable recording medium having embodied thereon a program, which when executed by a processor, controls a method, the method including:
determining a service priority group corresponding to a vehicle-to-everything (V2X) service; and
determining whether to use resources in exceptional resource pools for the V2X service based on the service priority group.

16. The non-transitory computer readable recording medium of claim 15, wherein the determining the service priority group includes determining the service priority group from among a plurality of service priority groups according to a priority level value in quality of service (QOS) parameters of the V2X service and configuration information of the plurality of service priority groups, wherein the plurality of service priority groups comprises a first priority service group, a second priority service group and a third priority service group.

17. The non-transitory computer readable recording medium of claim 16, wherein determining whether to use resources in exceptional resource pools for the V2X service based on the service priority group includes:
using, based on random selection, the resources in the exceptional resource pools to send data of the V2X service based on the service priority group being the first priority service group;
determining whether to use the resources in the exceptional resource pools for the V2X service based on a channel busy ratio based on the service priority group being the second priority service group; and
canceling data transmission of the V2X service based on the service priority group being the third priority service group.

18. The non-transitory computer readable recording medium of claim 17, wherein the determining whether to use the resources in the exceptional resource pools for the V2X service based on the channel busy ratio includes:
using, based on the random selection, the resources in the exceptional resource pools to send the data of the V2X service based on the channel busy ratio being less than a first threshold; and
canceling the data transmission of the V2X service based on the channel busy ratio being greater than or equal to the first threshold.

19. The non-transitory computer readable recording medium of claim 17, wherein the method further includes determining the channel busy ratio based on an amount of time that a received signal strength indicator exceeds a second threshold over a first time period.

20. The non-transitory computer readable recording medium of claim 16, wherein the method further includes receiving the configuration information of the plurality of service priority groups.
